(19) United States
(12) Patent Application Publication
(10) Pub. No.: US 2021/0104759 A1
(43) Pub. Date: Apr. 8, 2021

(54) FUEL CELL SYSTEM

(71) Applicant: HONDA MOTOR CO., LTD., Tokyo (JP)

(72) Inventor: Ryoichi YOSHITOMI, WAKO-SHI (JP)

(21) Appl. No.: 17/061,808

(22) Filed: Oct. 2, 2020

(30) Foreign Application Priority Data
Oct. 8, 2019 (JP) 2019-185183

(51) Int. Cl. H01M 8/04119

(52) U.S. Cl. CPC H01M 8/04164; H01M 2250/20

(57) ABSTRACT

A fuel cell system includes a fuel cell stack and a cathode gas system apparatus. The cathode gas system apparatus includes a humidifier, a discharge side gas liquid separator provided on the downstream side of a flow direction of a cathode off gas in the humidifier, and an expander provided on the downstream side of the flow direction of the cathode off gas in a discharge side gas liquid separator. In the order toward the lower side in the gravity direction, the humidifier, the discharge side gas liquid separator, and the expander are disposed in the fuel cell system.

### CROSS-REFERENCE TO RELATED APPLICATION

This application is based upon and claims the benefit of priority from Japanese Patent Application No. 2019-185183 filed on Oct. 8, 2019, the contents of which are incorporated herein by reference.

### BACKGROUND OF THE INVENTION

### Field of the Invention

The present invention relates to a fuel cell system including a cathode gas system apparatus for discharging a cathode off gas from a fuel cell stack.

### Description of the Related Art

A fuel cell system includes a fuel cell stack, an anode off gas for supplying an anode gas (fuel gas such as hydrogen) to the fuel cell stack and discharging an anode off gas from the fuel cell stack, and a cathode gas system apparatus for supplying a cathode gas (oxygen-containing gas such as the air) to the fuel cell stack, and discharging a cathode off gas from the fuel cell stack.

For example, Japanese Patent No. 5965423 discloses a fuel cell system including an anode gas system apparatus and a cathode gas system apparatus on a lateral side of one of end plates of a fuel cell stack. Further, in Japanese Patent No. 5965423, a humidifier as an auxiliary device of the cathode gas system apparatus is provided adjacent to the lower side of the anode gas system apparatus (fuel gas unit).

### SUMMARY OF THE INVENTION

In this regard, in the fuel cell stack, water is produced in the fuel cell stack (the water is also referred to as the produced water), and the produced water and the cathode off gas are discharged into a discharge system of the cathode gas system apparatus. When the outside temperature is lowered, the water causes inconveniences in auxiliary devices of the cathode gas system apparatus if freezing of the auxiliary devices occurs, and causes rust in pipes, the auxiliary device, etc. of the cathode gas system apparatus if the water is retained as stagnant water for long time. That is, it is required for the fuel cell system to smoothly discharge the water produced in the fuel cell stack while preventing the water from being retained in the pipes and the auxiliary devices of the cathode gas system apparatus.

The present invention relates to a technique of the fuel cell system as described above, and an object of the present invention is to provide a fuel cell system which makes it possible to smoothly discharge water produced in a fuel cell stack from a cathode gas system apparatus.

In order to achieve the above object, according to an aspect of the present invention, a fuel cell system is provided. The fuel cell system includes a fuel cell stack, and a cathode gas system apparatus configured to supply a cathode gas to the fuel cell stack, and discharge a cathode off gas from the fuel cell stack, wherein the cathode gas system apparatus includes a humidifier configured to humidify the cathode gas by water contained in the cathode off gas, a gas liquid separator provided on a downstream side of the humidifier in a flow direction of the cathode off gas, and configured to separate gas and liquid water in the cathode off gas, and an expander provided on a downstream side of the gas liquid separator in the flow direction of the cathode off gas, and configured to expand the gas, and wherein in order toward a lower side in a gravity direction, the humidifier, the gas liquid separator, and the expander are disposed.

In the fuel cell system as describe above, the humidifier, the gas liquid separator, and the expander are arranged in the order toward the lower side in the gravity direction. In this manner, it is possible to smoothly discharge the water produced in the fuel cell stack (produced water) by the weight of the water. Accordingly, in the fuel cell system, for example, when the outside temperature is decreased, it is possible to suitably suppress inconvenience of the auxiliary devices due to freezing of water, and formation of rust due to stagnation of water.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a diagram partially showing a fuel cell system according to a first embodiment of the present invention;

FIG. 2 is a front cross sectional view showing a fuel cell stack and an auxiliary device case;

FIG. 3 is a side view showing piping structure of a cathode gas system apparatus of the fuel cell system in FIG. 1;

FIG. 4 is a side view showing flow of the cathode gas system apparatus;

FIG. 5 is a partial cross sectional view showing the state of a water discharge pipe in the case where acceleration toward the rear side of a fuel cell vehicle is applied to the water discharge pipe;

FIG. 6 is a diagram partially showing a fuel cell system according to a second embodiment of the present invention; and

FIG. 7 is a side view showing piping structure of a cathode gas system apparatus of a fuel cell system in FIG. 6.

### DESCRIPTION OF THE PREFERRED EMBODIMENTS

Hereinafter, preferred embodiments of the present invention will be de described with reference to the accompanying drawings.

### First Embodiment

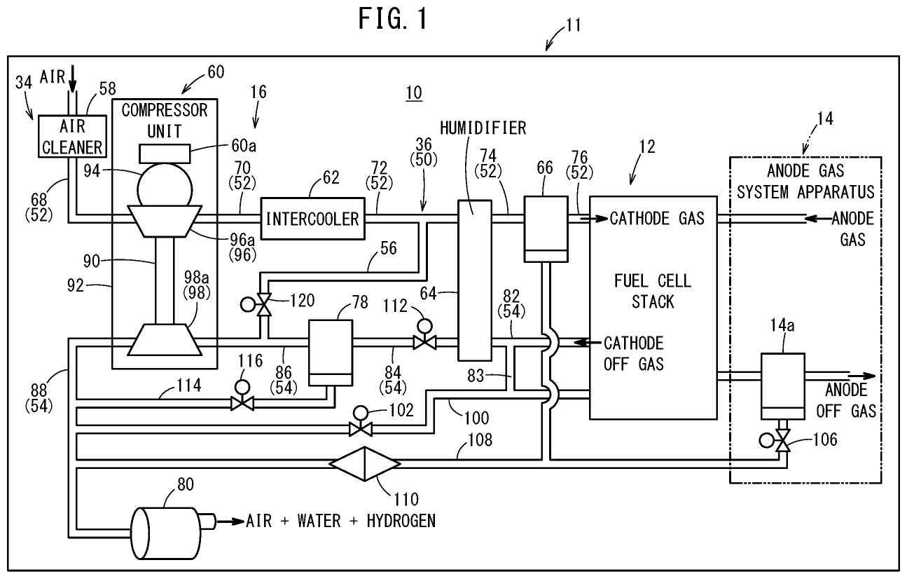

As shown in FIG. 1, a fuel cell system 10 according to a first embodiment of the present invention includes a fuel cell stack 12, an anode gas system apparatus 14, and a cathode gas system apparatus 16. The fuel cell stack 12 performs power generation partially consuming an anode gas (fuel gas such as hydrogen) supplied from the anode gas system apparatus 14, and a cathode gas (oxygen-containing gas such as air) supplied from the cathode gas system apparatus 16. For example, the fuel cell system 10 is mounted in a motor room, etc. of a fuel cell vehicle 11 (hereinafter also simply referred to as the “vehicle 11”).

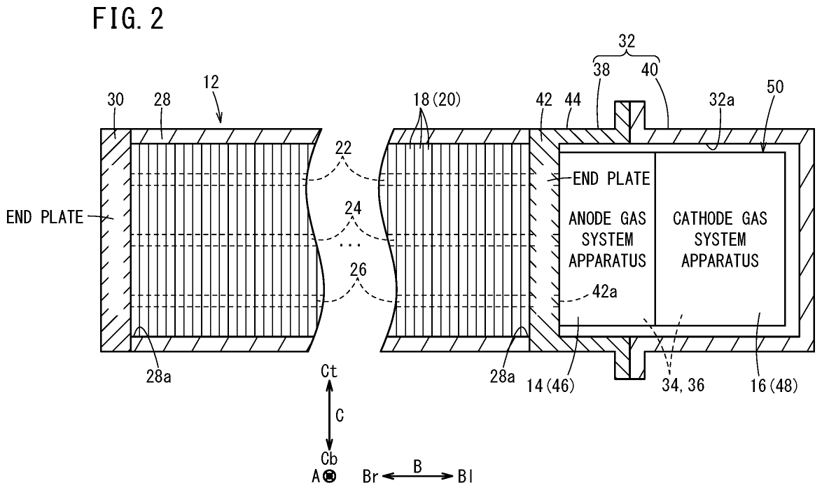

As shown in FIG. 2, the fuel cell stack 12 includes a plurality of power generation cells 18 for performing power generation by electrochemical reactions of an anode gas and a cathode gas. In the state where the fuel cell stack 12 is mounted in the vehicle 11, a plurality of power generation cells 18 are stacked together in a vehicle width direction (indicated by an arrow B) perpendicular to a vehicle length direction (toward the front side and back side of the paper: in a direction indicated by the arrow A) in a manner that electrode surfaces are oriented upright to form a stack body 20. It should be noted the plurality of power generation cells 18 may be stacked together in the vehicle length direction or in the gravity direction (indicated by an arrow C).

Each of the power generation cells 18 includes a membrane electrode assembly (not shown) (hereinafter referred to as the “MEA”) and two separators sandwiching the MEA. The outer peripheral portions of the power generation cells 18 that are adjacent to each other are joined together by welding, brazing, crimping, etc. to from a one piece joint separator.

The MEA of the power generation cell 18 includes an electrolyte membrane (e.g., solid polymer electrolyte membrane (cation exchange membrane)), an anode provided on one surface of the electrolyte membrane, and a cathode provided on the other surface of the electrolyte membrane (both of the anode and the cathode are not shown). An anode gas flow field as a passage of an anode gas and a cathode gas flow field as a passage of a cathode gas are formed on surfaces of two separators which face the MEA, respectively. Further, a coolant flow field as a passage of a coolant is formed on surfaces of the two separators which face each other. The anode gas flow field, the cathode gas flow field, and the coolant flow field allow each fluid to flow in the direction indicated by the arrow A.

Further, the plurality of power generation cells 18 (stack body 20) include a plurality of fluid passages (anode gas passages 22, cathode gas passages 24, and coolant passages 26) for allowing the anode gas, the cathode gas, and the coolant to flow independently along separator surfaces, respectively, in the stacking direction of the power generation cells 18 (indicated by the arrow B). In the stack body 20, the anode gas passages 22 are connected to the anode gas flow field, the cathode gas passages 24 are connected to the cathode gas flow field, and the coolant passages 26 are connected to the coolant flow field.

The anode gas supplied to the fuel cell stack 12 flows through the anode gas passage 22 (anode supply passage), and flows into the anode gas flow field. After the anode gas is partially consumed in the power generation at the anode, the resulting anode off gas flows from the anode gas flow field to the anode gas passage 22 (anode discharge passage), and the anode off gas is discharged to the outside of the fuel cell stack 12.

The cathode gas supplied to the fuel cell stack 12 flows through the cathode gas passage 24 (cathode supply passage), and flows into the cathode gas flow field. After the cathode gas is partially consumed in the power generation at the cathode, the resulting cathode off gas flows from the cathode gas flow field to the cathode gas passage 24 (cathode discharge passage), and the cathode off gas is discharged to the outside of the fuel cell stack 12.

The coolant supplied to the fuel cell stack 12 flows though the coolant passage 26 (coolant supply passage) into the coolant flow field. After the coolant cools the power generation cells 18, the coolant flows from the coolant flow field into the coolant passage 26 (coolant discharge passage), and the coolant is discharged to the outside of the fuel cell stack 12.

Further, the fuel cell stack 12 according to the embodiment of the present invention accommodates the stack body 20 in a stack case 28. Open holes 28a are formed on both side surfaces of the power generation cells 18 of the stack case 28 in the stacking direction (indicated by the arrow B). The open holes 28a are connected to an internal space of the stack case 28.

At one end of the stack body 20 in the direction indicated by the arrow B (indicated by an arrow Br), a terminal plate (not shown) is provided, and an insulating plate (not shown) is provided outside the terminal plate. The terminal plate and the insulating plate are accommodated in the stack case 28. An end plate 30 closing the open hole 28a of the stack case 28 is attached to the stack case 28 on the side indicated by the arrow Br. The end plate 30 applies a tightening load to the power generation cells 18 in the stacking direction of the power generation cells 18.

At the other end of the stack body 20 in the direction indicated by an arrow B (indicated by an arrow B1), a terminal plate (not shown) is provided, and an insulating plate (not shown) is provided outside the terminal plate. The terminal plate and the insulating plate are accommodated in the stack case 28. An auxiliary device case 32 is attached to the stack case 28 on the side indicated by the arrow B1 in a manner to close the open hole 28a.

The auxiliary device case 32 is a protection casing for accommodating and protecting part of auxiliary devices 34 and pipes 36 of the fuel cell system 10, and the auxiliary device case 32 is fixed to the stack case 28 on the side indicated by the arrow B1. The auxiliary device case 32 includes a first case member 38 having a recessed shape joined to the stack case 28, and a second case member 40 having a recessed shape joined to the first case member 38. An accommodation space 32a for accommodating the auxiliary devices 34 and the pipes 36 are formed inside these members.

The first case member 38 is joined to the stack case 28 using bolts, and includes an attachment wall 42 for diving the internal space of the stack case 28 and the accommodation space 32a of the auxiliary device case 32, and a peripheral wall 44 continuous with the outer periphery of the attachment wall 42 and extending in the direction indicated by the arrow B1. The attachment wall 42 serves as an end plate which applies tightening load to the stack body 20 of the power generation cells 18 in the stacking direction. Holes 42a connected to the anode gas passages 22, the cathode gas passage 24, and the coolant passages 26 of the power generation cells 18 are formed in the attachment wall 42. The holes 42a are connected to the pipes 36 as passages of fluid.

Further, the auxiliary device case 32 includes a first space 46 provided adjacent to the attachment wall 42, and a second space 48 provided adjacent to the first space 46. The anode gas system apparatus 14 is chiefly provided in the first space 46, and the cathode gas system apparatus 16 is chiefly provided the second space 48. Piping structure 50 of the fuel cell system 10 according to the embodiment of the present invention chiefly relates to the cathode gas system apparatus 16. Part of the piping structure 50 is provided in the second space 48 of the auxiliary device case 32, and the remaining part of the piping structure is provided outside the auxiliary device case 32.

Referring back to FIG. 1, next, overall structure of the cathode gas system apparatus 16 will be described below. As the pipes 36 of the piping structure 50, the cathode gas system apparatus 16 includes a supply pipe 52 for supplying a cathode gas (air) from the outside to the fuel cell stack 12, and a discharge pipe 54 for discharging the cathode off gas from the fuel cell stack 12 to the outside. Further, the cathode gas system apparatus 16 includes a bypass pipe 56 connecting the supply pipe 52 and the discharge pipe 54. The bypass pipe 56 allows the cathode gas flowing through the supply pipe 52 to flow through the discharge pipe 54 without passing through the fuel cell stack 12.

The cathode gas system apparatus 16 includes a plurality of types of auxiliary devices 34 along the supply pipe 52 and the discharge pipe 54. Specifically, the supply pipe 52 of the cathode gas system apparatus 16 is provided with an air cleaner 58, a compressor 96 (compressor unit 60), an intercooler 62, a humidifier 64, and a supply side gas liquid separator 66, in the order from the upstream side to the downstream side in the flow direction of the cathode gas. Therefore, the supply pipe 52 includes a first supply pipe 68 connecting the air cleaner 58 and the compressor 96, and a second supply pipe 70 connecting the compressor 96 and the intercooler 62, a third supply pipe 72 connecting the intercooler 62 and the humidifier 64, a fourth supply pipe 74 connecting the humidifier 64 and the supply side gas liquid separator 66, and a fifth supply pipe 76 connecting the supply side gas liquid separator 66 and the fuel cell stack 12.

Further, the discharge pipe 54 of the cathode gas system apparatus 16 is provided with the humidifier 64, a discharge side gas liquid separator 78, an expander 98 (compressor unit 60), and a dilution device 80, from the upstream side to the downstream side in the flow direction of the cathode off gas. Therefore, in the discharge pipe 54, the discharge pipe 54 is made up of a first discharge pipe 82 connecting the fuel cell stack 12 and the humidifier 64, a second discharge pipe 84 connecting the humidifier 64 and the discharge side gas liquid separator 78, a third discharge pipe 86 connecting the discharge side gas liquid separator 78 and the expander 98, and a fourth discharge pipe 88 connecting the expander 98 and the dilution device 80.

The air cleaner 58 has an internal removal filter (not shown) to remove foreign matters (rubbish, dust, water, etc.) contained in the air taken from the outside, and discharges the air into the first supply pipe 68.

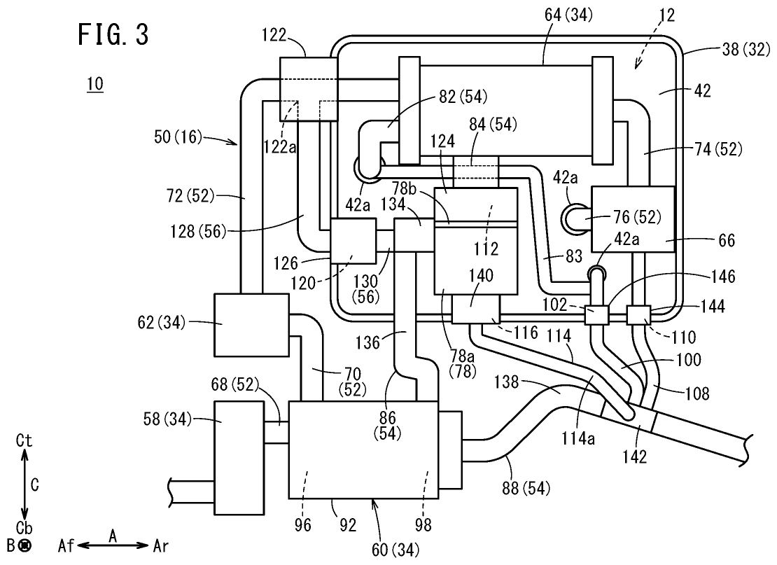

The compressor unit 60 includes a stator (not shown) and a rotor 90 in a casing 92 (see also FIG. 3), and also includes a motor mechanism 94 for rotating the rotor 90 consuming electrical energy supplied from the power supply (the fuel cell stack 12 and a battery (not shown)) of the fuel cell system 10. The rotor 90 includes a first fin 96a as part of a compressor 96 at one end, and a second fin 98a as part of the expander 98 at the other end. Further, the casing 92 includes a supply space of the compressor 96 connected to the first and second supply pipes 68, 70, and a discharge space of the expander 98 connected to the third and fourth discharge pipes 86, 88. The supply channel accommodates the first fin 96a, and the discharge space accommodates the second fin 98a.

The compressor unit 60 adjusts the rotation speed of the rotor 90 based on the electrical energy supplied from an inverter (Power Drive Unit: (PDU 60a)). The compressor 96 sucks the cathode gas from the first supply pipe 68 of the supply pipe 52 by rotation of the rotor 90 (first fin 96a), and discharges the compressed cathode gas (compressed air) into the second supply pipe 70.

The intercooler 62 cools the cathode gas supplied from the compressor 96 through the second supply pipe 70, and discharges the cathode gas into the third supply pipe 72. The intercooler 62 may adopts one of, or both of a cooling type system and a water cooling system. One end of the bypass pipe 56 is connected to the third supply pipe 72. The humidifier 64 utilizes the cathode off gas of the discharge pipe 54 to humidify the cathode gas supplied from the third supply pipe 72. That is, the cathode off gas includes water produced in the fuel cell stack 12 (produced water), and the humidifier 64 moves this water to humidify the cathode gas, and discharges the cathode gas into the fourth supply pipe 74.

The humidified cathode gas is supplied to the supply side gas liquid separator 66. The supply side gas liquid separator 66 removes water cotent from the cathode gas, and discharges the cathode gas into the fifth supply pipe 76. The fifth supply pipe 76 is connected to the hole 42a (see FIG. 2) connected to the cathode gas passage 24 of the fuel cell stack 12 for supplying the cathode gas to the fuel cell stack 12.

Further, the anode gas system apparatus 14 of the fuel cell system 10 is provided with a valve 106 for opening/closing the channel of the anode off gas. That is, in the fuel cell system 10, the valve 106 is opened/closed at suitable timing, to discharge the anode off gas (water and hydrogen gas) which flowed into a gas liquid separator 14a of the anode gas system apparatus 14 to the discharge system of the cathode gas system apparatus 16.

Further, a water discharge pipe 108 is connected to the supply side gas liquid separator 66, and the water discharge pipe 108 is connected to the fourth discharge pipe 88 through a predetermined route. An orifice 110 for adjusting the quantity of the discharged water is provided at a position somewhere along the water discharge pipe 108.

On the other hand, as described above, the water produced during the power generation of the fuel cell stack 12 and the cathode off gas are discharged into the first discharge pipe 82 of the cathode gas system apparatus 16. This cathode off gas flows from the first discharge pipe 82 into the humidifier 64 to humidify the cathode gas on the supply side. The water which has not been used in humidification and the cathode off gas are discharged into the second discharge pipe 84 connected to the downstream side of the humidifier 64.

Further, the fuel cell system 10 includes a drain discharge pipe 100 between the stack case 28 and the fourth discharge pipe 88, for discharging water of the fuel cell stack 12 from the cathode gas passages 24. A valve 102 for opening/closing the drain discharge pipe 100 is provided at a position somewhere along the drain discharge pipe 100.

Further, a branch pipe 83 connecting the first discharge pipe 82 and the drain discharge pipe 100 is provided at a position somewhere along the first discharge pipe 82. That is, in the state where the valve 102 is opened, some of the water flowing through the first discharge pipe 82 flows from the upstream side of the humidifier 64 into the branch pipe 83, and the water is discharged into the fourth discharge pipe 88.

The second discharge pipe 84 connected to the downstream side of the humidifier 64 in the flow direction of the cathode off gas is provided with a back pressure valve 112 for adjusting the pressure of the cathode gas. For example, the back pressure valve 112 comprises a butterfly valve, and the opening angle of the back pressure valve 112 is controlled base on the power generation current value required for the fuel cell stack 12, and the pressure value and the flow rate value detected by a pressure sensor and a flow rate member (not shown).

The discharge side gas liquid separator 78 separates the cathode off gas which flowed from the second discharge pipe 84 into the gas (chiefly the air) and liquid (liquid water) to decrease water, so as to reduce the water concentration in the cathode off gas. In addition to the second discharge pipe 84 and the third discharge pipe 86, a water discharge pipe 114 is connected to the discharge side gas liquid separator 78. The water discharge pipe 114 is connected to the fourth discharge pipe 88 which guides the water to the compressor unit 60. Further, the water discharge pipe 114 is provided with a valve 116. The valve 116 discharges the liquid water inside the discharge side gas liquid separator 78 by opening the valve 116, and interrupts discharge of the liquid water in the discharge side gas liquid separator 78 by closing the valve 116.

In the state where the gas contains water as little as possible, the discharge side gas liquid separator 78 discharges the gas (cathode off gas) into the third discharge pipe 86. To this end, for example, the discharge side gas liquid separator 78 is in the form of a cylindrical body 78a having a suitable depth in the gravity direction (see also FIG. 3). The third discharge pipe 86 allows the cathode off gas to flow through the expander 98.

In the expander 98, the second fin 98a rotates by the cathode off gas, and thus, the fluid energy of the cathode off gas is transmitted to the compressor 96. That is, the expander 98 functions as an apparatus of reproducing the fluid energy. Further, the expander 98 reduce the pressure of the cathode off gas by expanding the cathode off gas as a result of collection of the fluid energy, and discharge the cathode off gas into the fourth discharge pipe 88.

The other end of the bypass pipe 56 is connected to a position somewhere along the third discharge pipe 86. The bypass pipe 56 is provided with a bypass valve 120 for opening/closing the inside of the bypass pipe 56. The bypass valve 120 is opened/closed suitably the under the control of the ECU of the fuel cell system 10 for allowing the cathode gas the supply pipe 52 into the discharge pipe 54, and discharge the cathode gas through the discharge pipe 54.

The dilution device 80 has an internal filter (not shown), and the gas and the liquid which flowed through the fourth discharge pipe 88 flow into the dilution device 80. As described above, the water discharge pipe 108, 114, and the drain discharge pipe 100 are connected to the fourth discharge pipe 88. Therefore, the dilution device 80 dilutes the hydrogen, and then, discharges the hydrogen to the outside of the vehicle 11.

The cathode gas system apparatus 16 having the above structure contains a large quantity of water (produced in the fuel cell stack 12) on the upstream side of the discharge pipe 54 where the cathode off gas flows. Therefore, by adopting a suitable layout of the piping structure (second discharge pipe 84) of the discharge system of the cathode gas system apparatus 16, the difference in the height in the gravity direction is utilized to facilitate discharge of the water (liquid water) to prevent closure of the pipe, etc. due to freezing of the produced water.

Next, with reference to FIG. 3, the layout in the case where the cathode gas system apparatus 16 is mounted in the vehicle 11 will be described in detail below. Hereinafter, it should be noted that the positions and directions of each structure will be described based on notation indicated by arrows in FIG. 3 (or FIG. 2). In the drawings, the direction indicated by an arrow A corresponds to the front/rear direction of the vehicle 11, the direction indicated by an arrow Af corresponds to the front direction of the vehicle 11, and the direction indicated by an arrow Ar corresponds to the rear direction of the vehicle 11. In the drawings, the direction indicated by an arrow B is the left/right direction of the vehicle 11, the direction indicated by an arrow B1 is a left direction of the vehicle 11, and the direction indicated by the arrow Br is a right direction of the vehicle 11. In the drawing, the direction indicated by an arrow C is an upper/lower direction (gravity direction) of the vehicle 11, an arrow Ct corresponds to an upper direction of the vehicle 11, and the direction indicated by an arrow Cb corresponds to the lower direction of the vehicle 11.

FIG. 3 is a side view showing piping structure 50 of the cathode gas system apparatus 16 (fuel cell system 10) in the state where the second case member 40 is removed from the first case member 38 of the auxiliary device case 32. It should be noted that, as described above, the cathode gas system apparatus 16 is provided at a position adjacent to the outside of the anode gas system apparatus 14 (see also FIG. 2). Though not shown in FIG. 3, the auxiliary devices 34 and the pipes 36 of the anode gas system apparatus 14 are partially provided on the deep side of the cathode gas system apparatus 16.

At the time of mounting the fuel cell stack 12 in the vehicle 11, the fuel cell stack 12 is accommodated in a motor room using mount structure (not shown). The compressor unit 60 is disposed below the fuel cell stack 12 in the gravity direction (indicated by the arrow Cb), and the compressor unit 60 is spaced from the fuel cell stack 12, and fixed at a position overlapped with the fuel cell stack 12 on the side indicated by the arrow Af in a plan view. The air cleaner 58 and the intercooler 62 are disposed around the compressor unit 60. That is, the auxiliary devices 34 (the air cleaner 58, the compressor unit 60, and the intercooler 62) on the upstream side in the supply system of the cathode gas system apparatus 16 are provided outside the auxiliary device case 32.

On the other hand, the humidifier 64 of the cathode gas system apparatus 16 is provided on the lateral side of the fuel cell stack 12 (upper side in the auxiliary device case 32). Further, the supply side gas liquid separator 66 and the discharge side gas liquid separator 78 are provided below the humidifier 64 in the gravity direction (direction indicated by the arrow Cb: lower side in the auxiliary device case 32). The supply side gas liquid separator 66 is disposed on the side of the auxiliary device case 32 indicated by the arrow Ar, and the discharge side gas liquid separator 78 is provided on the side of the auxiliary device case 32 indicated by the arrow Af. That is, the humidifier 64 of the cathode gas system apparatus 16 and the two gas liquid separators 66, 78 are accommodated in the auxiliary device case 32.

In the supply pipe 52 and the discharge pipe 54 of the cathode gas system apparatus 16, the auxiliary devices 34 disposed as described above are coupled together under the connection relationship shown in FIG. 1. Specifically, the first supply pipe 68 connects the upper end of the air cleaner 58 and the side of the casing 92 of the compressor unit 60 indicated by the arrow Af. The second supply pipe 70 is connected between the upper part of the compressor unit 60 indicated by the arrow Af and the side of the intercooler 62 indicated by the arrow Ar.

The third supply pipe 72 connects the upper part of the intercooler 62 and the side of the humidifier 64 indicated by the arrow Af. The third supply pipe 72 has a connector member 122 fixed to the auxiliary device case 32 in a manner that the third supply pipe 72 penetrates from the outside and the inside of the auxiliary device case 32. The connector member 122 is a T type connector or a Y type connector having a branch part 122a connected to the bypass pipe 56 outside the auxiliary device case 32.

The fourth supply pipe 74 connects the side of the humidifier 64 indicated by the arrow Ar and the upper part of the supply side gas liquid separator 66. Further, the fifth supply pipe 76 connecting the supply side gas liquid separator 66 and the fuel cell stack 12 is connected to the hole 42a of the attachment wall 42.

On the other hand, the first discharge pipe 82 connects the side of the fuel cell stack 12 indicated by the arrow Af and an intermediate part thereof in the direction indicated by the arrow C, and the side of the humidifier 64 in the direction indicated by the arrow Af. The branch pipe 83 branched from the first discharge pipe 82 extends in the direction indicated by the arrow Ar, and then, extends downward, and is connected to the drain discharge pipe 100. The second discharge pipe 84 protrudes downward in the gravity direction (indicated by the arrow Cb) from the lower side of the cylindrical side surface of the humidifier 64, and is connected to an upper end 78b of the discharge side gas liquid separator 78. A back pressure valve 112 is provided inside a joint 124 provided at a portion connecting the second discharge pipe 84 and the discharge side gas liquid separator 78.

The discharge side gas liquid separator 78 extends from the upper end 78b connected to the second discharge pipe 84 in the direction indicated by the arrow Cb by a predetermined distance, and formed in a T shaped cylindrical body 78a having a protrusion 134 protruding in the direction indicated by the arrow A from a position adjacent to the upper end 78b. Water separated from the cathode off gas is stored in the lower portion of the cylindrical body 78a. The discharge side gas liquid separator 78 then discharges the liquid water in a direction of extending straight a route of the cathode off gas which flowed into the discharge side gas liquid separator 78 from the humidifier 64, the route facing downward in the gravity direction. The gas separated from the water flows through the protrusion 134 of the discharge side gas liquid separator 78. The third discharge pipe 86 and the bypass pipe 56 are connected to the protrusion 134.

The bypass pipe 56 includes an outer pipe 128 which extends from the connector member 122 outside the auxiliary device case 32 in the direction indicated by the arrow Cb and which is connected to a valve equipped connector member 126 fixed to a lower part of the auxiliary device case 32, and an internal pipe 130 extending from the valve equipped connector member 126 toward the protrusion 134 in the auxiliary device case 32. The bypass valve 120 is provided inside the valve equipped connector member 126.

The third discharge pipe 86 is connected to the protrusion 134, and includes a connector part (not shown) fixed to the auxiliary device case 32, and also includes an outer pipe 136 extending from the connector part in the direction indicated by the arrow Cb, and is connected to the compressor unit 60. The outer pipe 136 is connected to the outer peripheral surface of the compressor unit 60 (the cylindrical casing 92) on the side indicated by the arrow Ar.

The fourth discharge pipe 88 extends from the center at the end surface of the compressor unit 60 (casing 92) on the side indicated by the arrow Ar toward the side in the direction indicated by the arrow Ar. The fourth discharge pipe 88 extends from the casing 92 in the direction indicated by the arrow Ar and obliquely upward by a predetermined length, and extends to a curved portion 138 provided at a predetermined position in the fourth discharge pipe 88. Further, the fourth discharge pipe 88 is curved at the curved portion 138, and extends in the direction indicated by the arrow Ar and downward obliquely again, and is connected the dilution device 80 (see FIG. 1). For example, the dilution device 80 is provided on the side of the vehicle 11 indicated by the arrow Ar.

The water discharge pipe 114 of the discharge side gas liquid separator 78 is fixed to the auxiliary device case 32, and connected to the lower end of the cylindrical body 78a through a valve equipped connector member 140 which has an internal valve 116. The water discharge pipe 114 is exposed to the outside of the auxiliary device case 32, and extends in the direction indicated by the arrow Ar and downward obliquely gently in the motor room. Further, the water discharge pipe 114 is curved slightly at a position 114a somewhere in water discharge pipe 114, and after the water discharge pipe 114 is curved downward at a steep angle, the water discharge pipe 114 is connected to a connector 142 of the fourth discharge pipe 88. The connector 142 of the fourth discharge pipe 88 is provided at a position remote from the curved portion 138 of the fourth discharge pipe 88 (from the compressor unit 60) toward the side indicated by the arrow Ar (toward the downstream side).

Further, the water discharge pipe 108 of the supply side gas liquid separator 66 is connected to the lower end of the supply side gas liquid separator 66 through an orifice equipped connector member 144 attached to the auxiliary device case 32. The orifice 110 is provided inside the orifice equipped connector member 144. The water discharge pipe 108 is exposed to the outside of the auxiliary device case 32, and extends downward. The water discharge pipe 108 is connected to the connector 142 of the fourth discharge pipe 88.

Further, the drain discharge pipe 100 protrudes from the hole 42a of the fuel cell stack 12 on the side indicated by the arrow Cb, extends downward through a valve equipped connector member 146 having the valve 102, and is connected to the connector 142. For example, it is adequate that the connector 142 is in the form of a manifold having branches capable of connecting a plurality of pipes 36 (the drain discharge pipe 100 and the water discharge pipes 108, 114) to the main pipe 36 (fourth discharge pipe 88).

In summary, the auxiliary devices 34 in the discharge system for discharging the cathode off gas system has the positional relationship where, in the cathode gas system apparatus 16, in the order toward the lower side in the gravity direction (in the direction indicated by the arrow Cb), the humidifier 64, the back pressure valve 112, the discharge side gas liquid separator 78, and the valve 116 are disposed on the lateral side of the fuel cell stack 12. That is, on the downstream side of the humidifier 64, the water contained in the cathode off gas flows substantially straight through the route toward the lower side in the gravity direction (indicated by the arrow Cb). Further, the gas route of the cathode off gas extends toward the lower side in the gravity direction (indicated by the arrow Cb), at a position shifted in the direction indicated by the arrow A (direction indicated by the arrow Af) from the route of the water.

Further, the bypass pipe 56 (and the bypass valve 120) bypassing the cathode gas is provided at the same height as the back pressure valve 112 and the upper portion (protrusion 134) of the discharge side gas liquid separator 78. Further, the valve 102 provided for the drain discharge pipe 100 is positioned on the same height as the valve 116. The drain discharge pipe 100 and the water discharge pipes 108, 114 extend downward in the gravity direction (indicated by the arrow Cb), and are connected to the connector 142 of the fourth discharge pipe 88 below the auxiliary device case 32 in the gravity direction (direction indicated by arrow Cb).

The fuel cell system 10 according to the embodiment of the present invention basically has the above structure. Next, operation of the fuel cell system 10 will be described below.

As shown in FIG. 1, in the fuel cell system 10, during power generation of the fuel cell stack 12, the anode gas system apparatus 14 supplies the anode gas to the fuel cell stack 12, and discharges the anode gas from the fuel cell stack 12. Further, in the fuel cell system 10, during the power generation of the fuel cell stack 12, the cathode gas system apparatus 16 supplies the cathode gas to the fuel cell stack 12, and discharges the cathode gas from the fuel cell stack 12.

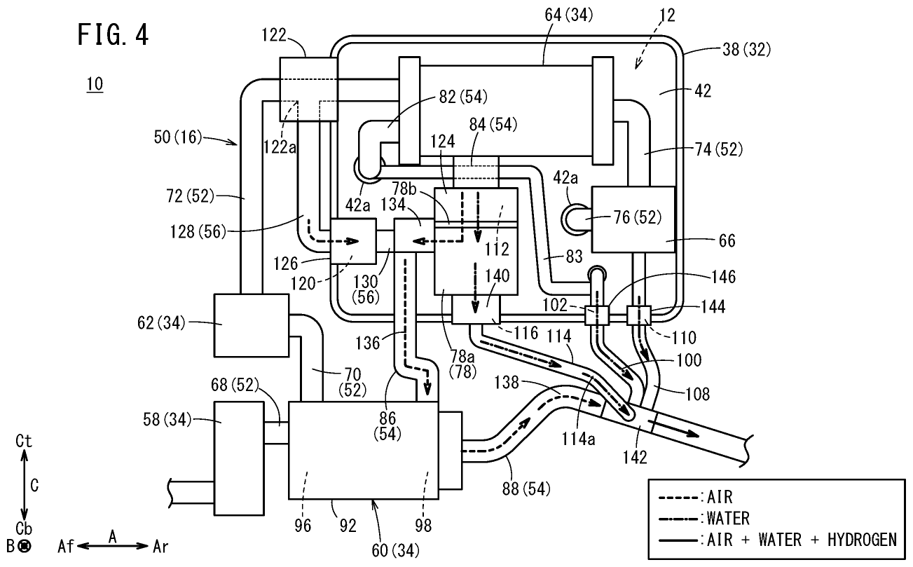

Specifically, as shown in FIGS. 1 and 4, the cathode gas system apparatus 16 allows the cathode gas to flow into the first supply pipe 68 through the air cleaner 58 This cathode gas is pressurized based on driving of the compressor 96, and the cathode gas is supplied to the humidifier 64 through the second supply pipe 70, the intercooler 62, and the third supply pipe 72. Then, after the cathode gas is humidified by the humidifier 64, the cathode gas is supplied to the fuel cell stack 12 through the fourth supply pipe 74, the supply side gas liquid separator 66, and the fifth supply pipe 76.

The cathode gas is partially consumed in the power generation of the fuel cell stack 12 to produce the cathode off gas containing a large quantity of water. The cathode off gas is discharged from the fuel cell stack 12 into the first discharge pipe 82. When the cathode off gas flows from the first discharge pipe 82 into the humidifier 64, the cathode off gas humidifies the cathode gas by the water contained in the cathode off gas, and then, the cathode gas containing the remaining water is discharged into the second discharge pipe 84.

Further, the cathode off gas flows from the second discharge pipe 84 into the discharge side gas liquid separator 78, and then, the cathode off gas is separated into the gas and liquid (liquid water) by the discharge side gas liquid separator 78. After the liquid water is separated from the cathode off gas by the discharge side gas liquid separator 78, the cathode off gas flows through the expander 98 through the third discharge pipe 86 connected to the protrusion 134 of the discharge side gas liquid separator 78. The liquid water contained in the cathode off gas discharged to the downstream side of the discharge side gas liquid separator 78 is small. Therefore, as to the expander 98, operation failures due to the entry of the liquid water are suppressed, and it is possible to maintain the suitable operation state.

Further, in the auxiliary device case 32, the cathode gas system apparatus 16 discharges the water in the cathode off gas downward in the gravity direction (direction indicated by the arrow Cb). That is, the water contained in the cathode off gas flows substantially straight through the humidifier 64, the joint 124 (back pressure valve 112), and the discharge side gas liquid separator 78 that are arranged in the order toward the lower side in the gravity direction, and the water is removed from the gas in the discharge side gas liquid separator 78 to produce liquid water. The discharge side gas liquid separator 78 discharges the liquid water directly along a route (on an extension line of the route) extending from the humidifier 64 substantially straight toward the lower side in the gravity direction. After the liquid water flows through the valve equipped connector member 140 (valve 116) provided below the discharge side gas liquid separator 78, the liquid water is discharged in the direction indicated by the arrow Cb with inclination in the direction indicated by the arrow Ar in the water discharge pipe 114 outside the auxiliary device case 32.

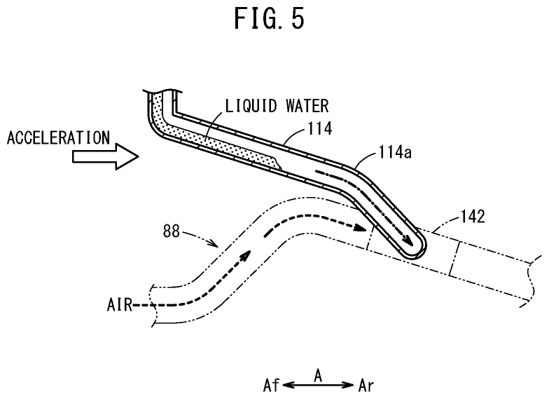

Therefore, the water contained in the cathode off gas smoothly flows downward in the gravity direction by its own weight, and stagnation of the water is suppressed. Further, as shown in FIG. 5, when acceleration is applied to the liquid water in the water discharge pipe 114 during forward movement of the vehicle 11, the liquid water smoothly moves in the direction indicated by the arrow Ar, in the water discharge pipe 114 extending in the direction indicated by the arrow Ar, and the liquid water is merged into the fourth discharge pipe 88. Therefore, the liquid water can be suitably discharged from the discharge side gas liquid separator 78.

The fourth discharge pipe 88 extends from the expander 98 in the direction indicated by the arrow Ar and obliquely upward to some extent, and then, extends from the curved portion 138 in the direction indicated by the arrow Ar and obliquely downward. The liquid water which flows into the fourth discharge pipe 88 through the water discharge pipe 114 is merged from the connector 142 on the rear side of the curved portion 138 to prevent backflow toward the expander 98. It should be noted that, as described above, the water in the drain discharge pipe 100, and the liquid water in the supply side gas liquid separator 66 though the water discharge pipe 108 and the hydrogen (anode off gas) flow into the connector 142 of the fourth discharge pipe 88. It is possible to prevent backflow of the liquid water toward the expander 98 as well. Further, the fourth discharge pipe 88 allows the cathode off gas (air), the water, and the anode off gas (hydrogen) to flow through the discharge channel positioned on one side of the connector 142 in the direction indicated by the arrow Ar, and discharge the cathode off gas (air), the water, and the anode off gas (hydrogen) to the outside of the vehicle 11 through the dilution device 80.

### Second Embodiment

Next, a fuel cell system 10A according to a second embodiment of the present invention will be described below. In the following description, the constituent elements of the fuel cell system 10A having the same structure or the same function as the fuel cell system 10 are labelled with the same reference numeral, and the detailed description is omitted.

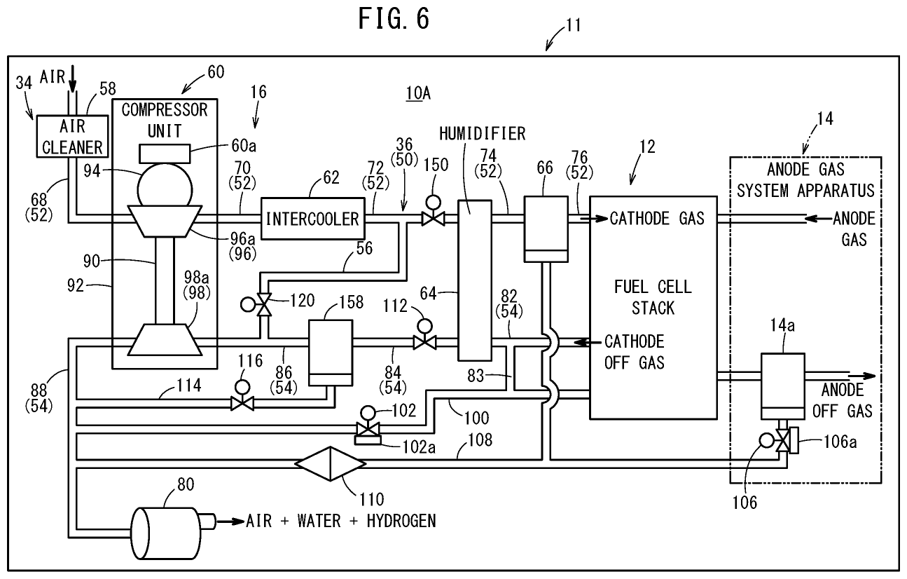

As shown in FIG. 6, the fuel cell system 10A is different from the fuel cell system 10 in that the fuel cell system 10A has a supply side valve 150 at a position somewhere along the supply pipe 52 (third supply pipe 72). The supply side valve 150 is opened/closed under control of an ECU (not shown) to supply or stop supply of the cathode gas from the supply pipe 52 to the fuel cell stack 12.

Further, in the fuel cell system 10A, valves 102, 106 at positions where the water flows (the drain discharge pipe 100 and the water discharge pipe 108 of the anode gas system apparatus 14) are provided with heaters 102a, 106a, respectively. Under the low temperature environment, the heaters 102a, 106a heat the valves 102, 106 to avoid operation failures (closure, etc.) of the valves 102, 106 due to freezing of the water.

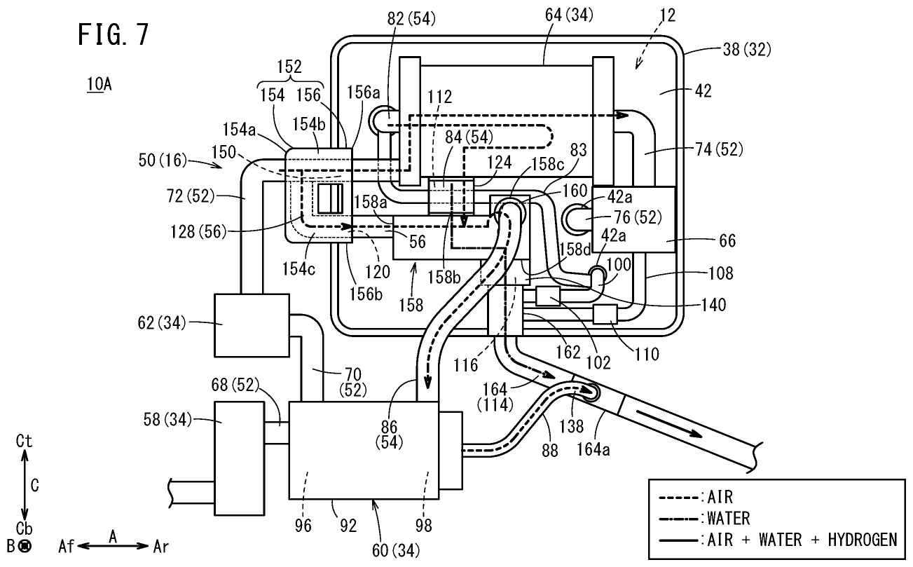

Further, as shown in FIG. 7, the fuel cell system 10A includes a unit structural body 152 forming a branch part of the third supply pipe 72 and the bypass pipe 56. The unit structural body 152 includes an outer fixing manifold 154 provided outside the auxiliary device case 32, and a valve unit 156 coupled to the outer fixing manifold 154 and accommodated inside the auxiliary device case 32.

A flexible pipe of the third supply pipe 72 is connected to an upper end 154a of the outer fixing manifold 154. The outer fixing manifold 154 includes a first pipe 154b extending from the upper end 154a in the direction indicated by an arrow Ar and a second pipe 154c extending downward from the upper end 154a by a short distance and then, extending in the direction indicated by the arrow Ar.

The valve unit 156 includes a first cylindrical portion 156a extending inside the auxiliary device case 32 in the direction indicated by the arrow A by a short distance and connected to the first pipe 154b, and a second cylindrical portion 156b extending in the same manner in the direction indicated by the arrow A by a short distance and connected to the second pipe 154c. The first cylindrical portion 156a and the second cylindrical portion 156b are arranged in the direction indicated by the arrow C, and coupled together. Further, the supply side valve 150 is provided inside the first cylindrical portion 156a, and the bypass valve 120 is provided inside the second cylindrical portion 156b.

The first cylindrical portion 156a is connected to the humidifier 64 provided on the side of the valve unit 156 indicated by the arrow Ar, and the second cylindrical portion 156b is connected to a discharge side gas liquid separator 158 provided on the rear side in the direction indicated by the arrow A. That is, when the cathode gas flows through the third supply pipe 72 on the downstream side of the intercooler 62, in the state where the supply side valve 150 is opened, the cathode gas flows through the first pipe 154b, the first cylindrical portion 156a, and flows into the humidifier 64. Further, in the state where the bypass valve 120 is opened, the cathode gas flows through the second pipe 154c, the second cylindrical portion 156b, and then, the cathode gas flows into the discharge side gas liquid separator 158.

The discharge side gas liquid separator 158 is disposed below the humidifier 64 in the gravity direction (direction indicated by the arrow Cb) in the auxiliary device case 32, and extends in the direction indicated by the arrow A. The discharge side gas liquid separator 158 includes a supply system port 158a connected to the second cylindrical portion 156b as described above, and a discharge system port 158b connected to the joint 124 of the second discharge pipe 84 on the downstream side of the humidifier 64. The back pressure valve 112 is provided in the joint 124.

In the discharge side gas liquid separator 158, the cathode off gas of the second discharge pipe 84 in the internal space extending in the direction indicated by the arrow A is separated into the gas and liquid to decrease water to lower the water concentration in the cathode off gas. Then, at the end of the discharge side gas liquid separator 158 in the direction indicated by the arrow Ar, a gas discharge port 158c for discharging the gas (air, hydrogen, etc.), and a liquid discharge port 158d for discharging the separated liquid (liquid water) are provided.

The gas discharge port 158c is provided with a fixing connector 160 protruding upward from the main body part of the discharge side gas liquid separator 158. One end of the third discharge pipe 86 is connected to the fixing connector 160. The third discharge pipe 86 extends from the fixing connector 160 downward in the gravity direction, and the other end of the third discharge pipe 86 is connected to the expander 98. The liquid discharge port 158d is provided at a lower part of the discharge side gas liquid separator 158 in the direction indicated by the arrow Ar, and connected to a water discharge connector 162 through a valve equipped connector member 140 having an internal valve 116. That is, the discharge side gas liquid separator 158 discharges the liquid water downward in the gravity direction, at a position shifted in a horizontal direction from a route of the cathode off gas which flowed into the discharge side gas liquid separator 158 from the humidifier 64, the route facing downward in the gravity direction.

The water discharge connector 162 protrudes from the valve equipped connector member 140 downward in the gravity direction (indicated by the arrow Cb), and a water discharge pipe 114 is connected to the water discharge connector 162 outside the auxiliary device case 32. The water discharge pipe 108 connected to the supply side gas liquid separator 66 and the drain discharge pipe 100 connected to the branch pipe 83 are connected to the water discharge connector 162.

The water discharge pipe 114 comprises a hard pipe 164 (resin pipe, metal pipe) coupled to the lower end of the water discharge connector 162. The hard pipe 164 (discharge water pipe 114) extends from a connection portion of the water discharge connector 162 in the direction indicated by the arrow Ar, and is inclined downward gently. A connector 164a is provided at a position somewhere along the hard pipe 164 which extends obliquely downward. The fourth discharge pipe 88 is connected to the connector 164a in the direction indicated by the arrow B1 (see FIG. 2: vehicle width direction). The fourth discharge pipe 88 extends from the expander 98 in the direction indicated by the arrow Ar and obliquely upward (in the direction indicated by the arrow Ct), and after the fourth discharge pipe 88 extends up to the curved portion 138 positioned slightly above the connector 164a, the fourth discharge pipe 88 extends in the direction indicated by the arrow Ar and downward, and then, the fourth discharge pipe 88 is connected to the connector 164a.

Therefore, also in the discharge system of the cathode gas system apparatus 16 according to the second embodiment, in the order toward the lower side in the gravity direction (direction indicated by the arrow Cb) the humidifier 64, the back pressure valve 112, the discharge side gas liquid separator 158, and the valve 116 are disposed on the lateral side of the fuel cell stack 12. Further, the gas route of the cathode off gas extends downward in the gravity direction (direction indicated by the arrow Cb) from a position above the storage part (in the direction indicated by the arrow Ct) of the discharge side gas liquid separator 158.

Further, the bypass pipe 56 (and the bypass valve 120) bypassing the cathode gas is connected to the side of the discharge side gas liquid separator 158 in the direction indicated by the arrow Af. The drain discharge pipe 100 and the water discharge pipe 108 are connected to the water discharge connector 162 at a lower position inside the auxiliary device case 32. The hard pipe 164 connected to the lower end of the water discharge connector 162 extends downward in the gravity direction (indicated by the arrow Cb) and in the direction indicated by the arrow Ar.

The fuel cell system 10A according to the second embodiment basically has the above structure. Next, operation and advantages of the fuel cell system 10A will be described.

In the cathode gas system apparatus 16 of the fuel cell system 10A, the cathode gas is pressurized based on driving of the compressor 96. As a result, the cathode gas flows through the third supply pipe 72 in the direction indicated by the arrow Ct, and flows into the unit structural body 152. In the unit structural body 152, in the case where the supply side valve 150 is opened, the cathode gas is supplied to the humidifier 64 through the first pipe 154b and the first cylindrical portion 156a. After the cathode gas is humidified by the humidifier 64, the cathode gas is supplied from the humidifier 64 to the fuel cell stack 12 though the supply side gas liquid separator 66, etc.

The cathode off gas partially consumed in the power generation of the fuel cell stack 12 flows through the first discharge pipe 82 into the humidifier 64. In the humidifier 64, the cathode gas humidifies the cathode gas supplied by the water contained in the cathode gas, and then, the cathode off gas containing the remaining water is discharged, and flows into the discharge side gas liquid separator 158 through the discharge system port 158b.

Further, in the case where the bypass valve 120 is opened in the unit structural body 152, the cathode gas is supplied to the discharge side gas liquid separator 158 through the second pipe 154c, the second cylindrical portion 156b, and the supply system port 158a. In the discharge side gas liquid separator 158, the cathode gas or the cathode off gas moves in the direction indicated by the arrow Ar. The discharge side gas liquid separator 158 separates the gas and the liquid from each other during this movement. Then, the gas is discharged through the gas discharge port 158c at the upper portion of the discharge side gas liquid separator 158, and the fixing connector 160, and the gas moves along the third discharge pipe 86 toward the expander 98 in the direction indicated by the arrow Cb. The liquid water contained in this gas is small. Therefore, operation failures of the expander 98 due to flow of the liquid water into the expander 98 are suppressed, and it is possible to maintain the suitable operation state.

Further, the cathode gas system apparatus 16 of the fuel cell system 10A discharges the water contained in the cathode off gas toward the lower side in the gravity direction (indicated by the arrow Cb) in the auxiliary device case 32. That is, the water contained in the cathode off gas flows substantially straight through the humidifier 64, the joint 124 (back pressure valve 112), and the discharge side gas liquid separator 158 in this order that are arranged toward the lower side in the gravity direction, and the water is removed from the gas to produce liquid water, in the discharge side gas liquid separator 158. The liquid water in the discharge side gas liquid separator 158 is discharged downward in the direction of gravity, at the position shifted in the horizontal direction from the route of the cathode off gas which flows from the humidifier 64. This liquid water flows downward in the gravity direction through the valve equipped connector member 140 (valve 116), and the water discharge connector 162 that are provided on the lower side, and the liquid water is discharged through the water discharge pipe 114 (hard pipe 164) of the auxiliary device case 32 in the direction indicated by the arrow Cb with inclination in the direction indicated by the arrow Ar.

The inclination angle of the hard pipe 164 is fixed (the hard pipe 164 is not flexible). In the structure, the liquid water can be discharged through the hard pipe 164 smoothly. The liquid water is merged with gas discharged from the expander 98 in the connector 164a provided at a position somewhere along the hard pipe 164, and the liquid water is merged with the gas discharged from the expander 98. The liquid water flows inside the hard pipe 164 with inclination obliquely downward by its own weight. In the structure, backflow of the liquid water from the connector 164a toward the expander 98 through the fourth discharge pipe 88 is suppressed.

Technical concepts and advantages that can be understood from the above embodiments will be described below.

According to an aspect of the present invention, the fuel cell system 10, 10A is provided. The fuel cell system 10, 10A includes the fuel cell stack 12, and the cathode gas system apparatus 16 configured to supply the cathode gas to the fuel cell stack 12, and discharge a cathode off gas from the fuel cell stack 12, wherein the cathode gas system apparatus 16 includes the humidifier 64 configured to humidify the cathode gas by water contained in the cathode off gas, and the gas liquid separator (discharge side gas liquid separator 78, 158) provided on the downstream side of the humidifier 64 in the flow direction of the cathode off gas, and configured to separate gas and liquid water in the cathode off gas, and the expander 98 provided on the downstream side of the gas liquid separator in the flow direction of the cathode off gas, and configured to expand the gas, and wherein in the order toward the lower side in the gravity direction, the humidifier 64, the gas liquid separator, and the expander 98 are disposed.

In the fuel cell system 10, 10A, since the humidifier 64, the liquid separator (discharge side gas liquid separator 78, 158), and the expander 98 are disposed in the order toward the lower side in the gravity direction, it is possible to smoothly discharge the water produced in the fuel cell stack 12 (produced water) by the weight of the water. In this manner, in the fuel cell system 10, 10A, it is possible to suitably suppress malfunctions of the auxiliary devices 34 due to freezing of water, and formation of rust, etc. due to stagnation of water.

Further, the back pressure valve 112 configured to adjust the pressure of the cathode gas is provided between the humidifier 64 and the gas liquid separator (discharge side gas liquid separator 78, 158) in the flow direction of the cathode off gas, and in the order toward the lower side in the gravity direction, the humidifier 64, the back pressure valve 112, and the gas liquid separator are disposed. In this manner, the water produced in the fuel cell stack 12 can flow through the fuel cell system 10, 10A, in the order from the humidifier 64, the back pressure valve 112, and the gas liquid separator, and it becomes possible to suppress stagnation of water adjacent to the back pressure valve 112.

Further, the pipe (the third discharge pipe 86) is connected to the upper position of the gas liquid separator (discharge side gas liquid separator 78, 158) in the gravity direction, and the pipe (third discharge pipe 86) is connected to the expander 98. In this manner, the fuel cell systems 10, 10A can stably discharge the gas which does not contain liquid water separated in the gas liquid separator, from the gas liquid separator to the expander 98.

Further, the valve 116 is provided below the gas liquid separator (discharge side gas liquid separator 78, 158) in the gravity direction, when opened, the valve 116 is configured to discharge the liquid water in the gas liquid separator, and when closed, the valve 116 is configured to interrupt discharge of the liquid water in the gas liquid separator. In the structure of the fuel cell system 10, 10A, it becomes possible to smoothly move the liquid water from the gas liquid separator to the valve 116 provided on the lower side in the gravity direction, and reliably discharge the liquid water by opening the valve 116.

Further, the water discharge pipe 114 extending with inclination downward in the gravity direction is connected to the lower end of the valve 116. In this manner, the fuel cell system 10, 10A can smoothly discharge the liquid water from the valve 116 through the water discharge pipe 114.

The fuel cell stack 12 comprises the auxiliary device case 32 at one end of the plurality of power generation cells 18 in the stacking direction, and the humidifier 64 and the gas liquid separator (discharge side gas liquid separator 78, 158) are provided inside the auxiliary device case 32, and the expander 98 is provided outside the auxiliary device case 32. In the structure, in the fuel cell systems 10, 10A, it becomes possible to protect the humidifier 64 and the gas liquid separator by the auxiliary device case 32, and allows the cathode off gas to flow downward in the gravity direction stably in the auxiliary device case 32.

Further, the gas liquid separator (discharge side gas liquid separator 78) is configured to discharge the liquid water in a direction of extending straight a route of the cathode off gas which flowed into the gas liquid separator from the humidifier 64, the route facing downward in the gravity direction. In this manner, in the fuel cell system 10, it is possible to suppress stagnation of the liquid water separated in the gas liquid separator, and easily discharge the liquid water downward in the gravity direction with respect to the gas liquid separator.

Further, the gas liquid separator (discharge side gas liquid separator 158) is configured to discharge the liquid water downward in the gravity direction, at a position shifted in a horizontal direction from the route of the cathode off gas which flowed into the gas liquid separator from the humidifier 64, the route facing downward in the gravity direction. In this manner, in the fuel cell system 10A, it is possible to sufficiently separate liquid water from the cathode gas which temporarily flowed into the gas liquid separator. Therefore, the fuel cell system 10A can guide the cathode off gas which contains almost no water to the expander 98, and stably operate the expander 98.

While the invention has been particularly shown and described with reference to preferred embodiments, it will be understood that variations and modifications can be effected thereto by those skilled in the art without departing from

What is claimed is:

1. A fuel cell system comprising:
a fuel cell stack; and
a cathode gas system apparatus configured to supply a cathode gas to the fuel cell stack, and discharge a cathode off gas from the fuel cell stack,
wherein the cathode gas system apparatus comprises:
a humidifier configured to humidify the cathode gas by water contained in the cathode off gas;
a gas liquid separator provided on a downstream side of the humidifier in a flow direction of the cathode off gas, and configured to separate gas and liquid water in the cathode off gas; and
an expander provided on a downstream side of the gas liquid separator in the flow direction of the cathode off gas, and configured to expand the gas, and
wherein in order toward a lower side in a gravity direction, the humidifier, the gas liquid separator, and the expander are disposed.

2. The fuel cell system according to claim 1, comprising a back pressure valve configured to adjust a pressure of the cathode gas, between the humidifier and the gas liquid separator in the flow direction of the cathode off gas; and
in order toward the lower side in the gravity direction, the humidifier, the back pressure valve, and the gas liquid separator are disposed.

3. The fuel cell system according to claim 1, wherein a pipe is connected to an upper position of the gas liquid separator in the gravity direction, and the pipe is connected to the expander.

4. The fuel cell system according to claim 1, wherein a valve is provided below the gas liquid separator in the gravity direction,
when opened, the valve is configured to discharge the liquid water in the gas liquid separator, and when closed, the valve is configured to interrupt discharge of the liquid water in the gas liquid separator.

5. The fuel cell system according to claim 4, wherein a water discharge pipe extending with inclination downward in the gravity direction is connected to a lower end of the valve.

6. The fuel cell system according to claim 1, wherein the fuel cell stack comprises an auxiliary device case at one end of a plurality of power generation cells in a stacking direction; and
the humidifier and the gas liquid separator are provided inside the auxiliary device case; and
the expander is provided outside the auxiliary device case.

7. The fuel cell system according to claim 1, wherein the gas liquid separator is configured to discharge the liquid water in a direction of extending straight a route of the cathode off gas which flowed into the gas liquid separator from the humidifier, the route facing downward in the gravity direction.

8. The fuel cell system according to claim 1, wherein the gas liquid separator is configured to discharge the liquid water downward in the gravity direction, at a position shifted in a horizontal direction from a route of the cathode off gas which flowed into the gas liquid separator from the humidifier, the route facing downward in the gravity direction.
